(19) United States
(12) Patent Application Publication
(10) Pub. No.: US 2008/0309150 A1
(43) Pub. Date: Dec. 18, 2008

(54) Visual special effects wheel covers

(76) Inventor: Lynn Edelman, Columbus, OH (US)

Correspondence Address: JAMES RAY & ASSOCIATES, 2640 PITCAIRN ROAD, MONROEVILLE, PA, 15146, US

(21) Appl. No.: 12/157,038

(22) Filed: Jun. 6, 2008

Related U.S. Application Data
(60) Provisional application No. 60/944,289, filed on Jun. 15, 2007.

(51) Int. Cl. B60B 7/00; B60B 7/20

(52) U.S. Cl. 301/37.25

(57) ABSTRACT

A novelty wheel cover assembly mounts on a corresponding rim of a vehicle wheel for displaying indicia while the wheel rotates and includes a solid disk member having an outside diameter less than that of the lip of the corresponding rim of a vehicle wheel, and a multiple-blade member with at least two substantially flat blades emanates from a central hub, wherein the central hub includes an axial spindle. A bearing assembly is imbedded at a center axis of the solid disk member and rotatably engages with the axial spindle with minimal friction. The multiple-blade member removably attaches to the corresponding rim of a vehicle wheel, and indicia decorate a portion of the outward-facing area of the solid disk assembly, which is inhibited from rotating by an outer edge weight on one side combined with the low-friction bearing assembly.

### CROSS REFERENCE TO RELATED APPLICATION

This patent application is related to and claims priority from U.S. Provisional Patent Application Ser. No. 60/944,289 filed Jun. 15, 2007.

### FIELD OF THE INVENTION

The present invention relates, in general, to special effects wheel covers for automobiles and, more particularly, this invention relates to wheel covers that reveal a full image only when the wheel is rotating at typical street or road speeds.

### BACKGROUND OF THE INVENTION

Prior to the conception and development of the present invention, many have disclosed various ways of adding special effects to wheel covers on vehicles such as automobiles and pick-up trucks. Over many decades, there have been numerous ways described to display advertising on a wheel cover which remains readable while the rotating. Three examples can be found in U.S. Pat. Nos. 710,195, 5,490,342 and 4,678,239. A multitude of others have disclosed various means of preventing spinning of the outer visible portion of the wheel cover while still being attached somehow to the wheel assembly.

Others have disclosed various means of providing the novelty visual effect of a wheel cover spinning at a different speed than the wheel and/or continuing to spin after the vehicle has stopped. In U.S. Pat. No. 6,554,370, Fowlkes describes how a spoked outer section of a wheel cover can be made to rotate at a different speed than the wheel, and then continue to spin after the wheel stops spinning. Yang in U.S. Pat. No. 7,014,273 discloses a spoked outer spinner that rotates independent of the wheel, while a central disc with indicia remains readable while the vehicle is moving. To the applicant's knowledge, the prior art does not disclose a full-wheel non-rotating image partially covered by a bladed spinning element.

### SUMMARY OF THE INVENTION

The present invention provides a novelty wheel cover assembly that mounts on a corresponding rim of a vehicle wheel for displaying indicia while the wheel rotates, and includes a solid disk member having an outside diameter less than that of the lip of the corresponding rim of a vehicle wheel. Also, a multiple-blade member with at least two substantially flat blades emanates from a central hub, wherein the central hub includes an axial spindle. A bearing assembly is imbedded at a center axis of the solid disk member and rotatably engages with the axial spindle with minimal friction. The multiple-blade member removably attaches to the corresponding rim of a vehicle wheel, and indicia decorate a portion of the outward-facing area of the solid disk assembly, which is inhibited from rotating by an outer edge weight on one side combined with the low friction bearing assembly.

### OBJECTS OF THE INVENTION

It is, therefore, one of the primary objects of the present invention to provide an attractive wheel cover for vehicle wheels.

Another object of the present invention is to provide a relatively simple and cost effective wheel cover that can display custom images visible to observers while traveling at street and highway speeds.

Still another object of the present invention is to provide a novelty type of wheel cover with images that remain upright and become completely visible only when the wheel is rotating at normal speeds.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a front elevation view of an exemplary embodiment of the present invention.

FIG. 2 is a side elevation view partially in cross section of one embodiment of the present invention.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

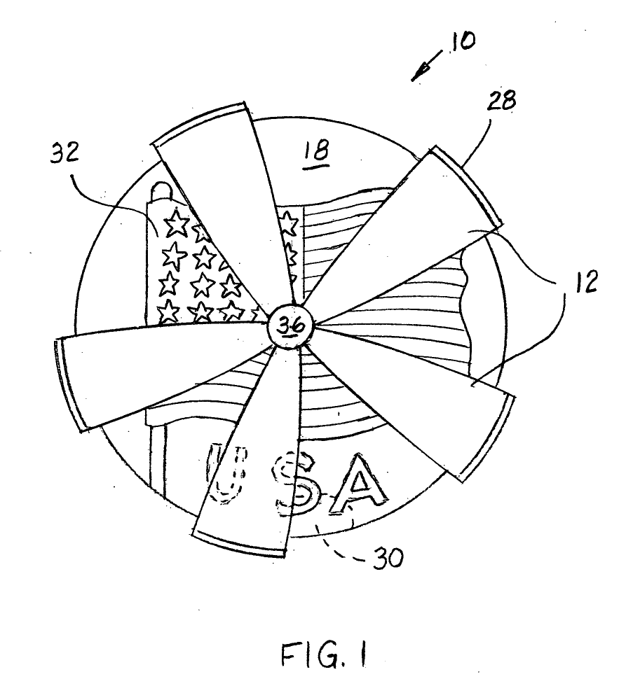

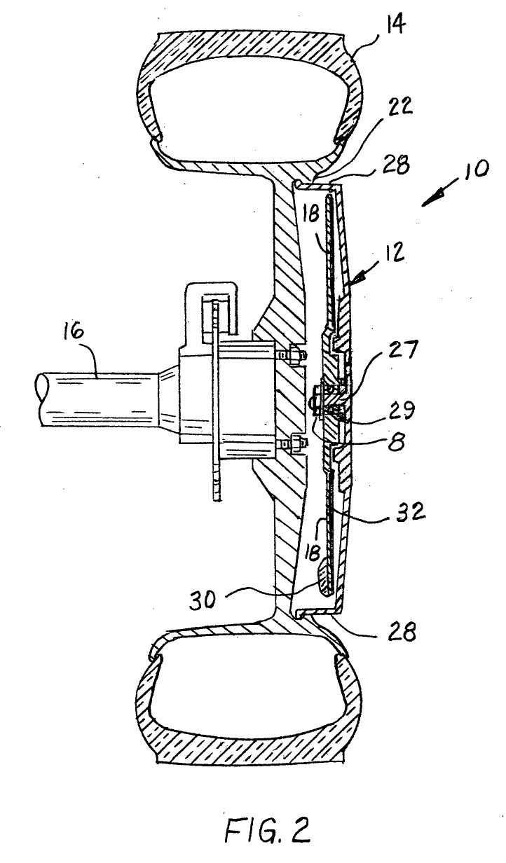

Referring initially to FIG. 1, the present invention, generally shown as 10, is presented as a front elevation view in an at-rest position. A disk 18, slightly smaller in diameter than the target vehicle wheel, is adorned with indicia disposed on the outward facing surface of disk 18. On the backside of the disk 18, near the bottom edge when the indicia 32 are in an upright position, a weight 30 is permanently attached. This weight serves to inhibit rotation of the disk 18 when the wheel is turning. This aspect of the design has been revealed multiple times in prior art extending over 100 years in U.S. patents such as those numbered U.S. Pat. Nos. 710,195 and 7,014,273. Such art is incorporated herein by reference, however, it appears that the prior art discloses the technique applied only to the outer member. At least two flat blades 12 extend out radially from a central hub 36 substantially in parallel to and proximal to the disk 18. The flat blades have a radius very similar to that of the inside of the wheel rim where the blades will attach. At the outer tips of the flat blades are semi rigid flanges 28 disposed substantially perpendicular to the blades. The disk 18 and central hub 36 are rotatably connected with a spindle-bearings-nut assembly as detailed further on FIG. 2.

FIG. 2 provides a side elevation view partly in section of the same embodiment of the present invention. An automobile tire 14 is mounted on a standard rim 22 and the wheel assembly is bolted to a vehicle axle 16 in the typical fashion. Multiple substantially flat blades 12 emanate radially from a central spindle 27 out to a radius approaching that of the rim 22. These blades 12 are of sufficient width and number to obscure at least a third of the surface area of the inside solid disk 18. At the outer edges, semi-rigid flanges 28 bend inward with sufficient dimensions and flex as to removably engage with the lip of the rim 22. The desired indicia 32 are permanently or removably attached to the outer surface of disk 18. The disk 18 and blades 12 are rotatably connected at the center with a spindle 27 integrally connected to the hub of the blades 12. A ring bearing assembly 29 is attached to the center of the disk 18 and surrounds the spindle 27. A nut/washer assembly 8 at the inside end of the spindle 27 loosely retains the disk 18 close to the blades 12. Because of the bearings assembly 29, the disk 18 has little tendency to rotate with the blades 12, which are rotating at the same rpms as the wheel 22 to which they are attached. A weight 30 at what is the desired bottom edge of the disk maintains the indicia 32 in the preferred upright position provided the spindle-bearing connection is substantially frictionless. At sufficiently high rotational speeds, the blur of the blades 12 makes them appear somewhat invisible and the whole image 32 behind becomes visible to an observer, thus creating the desired effect.

While a presently preferred embodiment of the present invention has been described in sufficient detail above to enable a person skilled in the relevant art to make and use the same, it should be obvious that various other adaptations and modifications can be envisioned by those persons skilled in such art without departing from either the spirit of the invention or the scope of the appended claims.

What is claimed is:

1. A wheel cover display assembly mountable on a corresponding rim of a vehicle wheel comprising:
a) a solid disk member having an outside diameter less than that of an inside lip of said corresponding rim of a vehicle wheel;
b) a multiple-blade member with at least two substantially flat blades emanating from a central hub, wherein said central hub includes an axial spindle;
c) a bearing assembly disposed at a center axis of said solid disk member and rotatably engageable with said axial spindle;
d) rim engagement means disposed at distal ends of said flat blades to enable removably attaching said multiple-blade member to said corresponding rim of a vehicle wheel;
e) indicia decorating a predetermined portion of an outward-facing area of said solid disk assembly and disposed between said flat blades and said corresponding rim;
f) a weight disposed proximal a portion of an edge of said solid disk member; and
g) a preselected retention means disposed at a distal end of said axial spindle in order to retain said bearing assembly on said axial spindle with minimal friction.

2. The wheel cover display assembly, according to claim 1, wherein said preselected retention means is a bolt-washer unit threaded into said distal end of said axial spindle.

3. The wheel cover display assembly, according to claim 1, wherein said rim engagement means are semi-rigid flanges disposed at distal ends of said flat blades.
